(19) United States
(12) Patent Application Publication
(10) Pub. No.: US 2010/0075700 A1
(43) Pub. Date: Mar. 25, 2010

(54) Flexible capacity short message service center (SMSC)

(75) Inventors: Paul Casto, Bowie, MD (US); Dennis F. Meyer, Annapolis, MD (US)

Correspondence Address: LAWRENCE HARBIN;HARBIN & HEIN PLLC, 500 NINTH STREET SE, WASHINGTON, DC, 20003, US

(73) Assignee: KABUSHIKI KAISHA TOSHIBA

(21) Appl. No.: 12/461,856

(22) Filed: Aug. 26, 2009

Related U.S. Application Data
(60) Provisional application No. 61/136,310, filed on Aug. 27, 2008.

(51) Int. Cl. H04W 4/00

(52) U.S. Cl. 455/466

(57) ABSTRACT

The present invention takes the advantages of a First-Delivery-Attempt (FDA) system/Short Message Service Center (SMSC) combination. The FDA/SMSC combination has the advantages of SS7-clustering and IP load-distribution, and adds call-flow and business logic to eliminate the disadvantages created in stand-alone architectures using those technologies in isolation. All messages can be addressed to a single destination, with the FDA/SMSC combination performing load distribution for delivery of the messages. Nodes can be added to the message processing system to increase capacity, with no configuration changes being required in an SS7 network or an external IP network.

The present application claims the benefit of U.S. Provisional Application No. 61/136,310, entitled “Flexible Capacity Short Message Service Center (SMSC)”, filed Aug. 27, 2008, to Casto et al., the entirety of which is explicitly incorporated herein by reference.

### BACKGROUND OF THE INVENTION

1. Field of the Invention

This invention relates generally to wireless telecommunication systems, and more particularly to short message service center services in a wireless telecommunications system.

2. Background of Related Art

In the early 1990s, as a result of the growing popularity of digital wireless technology, a standard for digital wireless networks was introduced in Europe. That standard, now known as the global standard for mobiles (GSM), included a service called short messaging service (SMS). An SMS allows transmission of short messages, typically up to 160 characters, to and from communication devices, e.g., cellular telephone handsets, telephones or computers with appropriate modems.

In North America, short message services are now a mainstay in wireless devices, enjoying immense popularity, particularly in the United States. Short message services are advantageous over text based paging services because of the capability of bi-directional communication. Such bi-directional communication allows, for example, notification to the originating device of the success or failure of the short message delivery.

Each SMS network typically includes a short message service center (SMSC) which acts as a store-and-forward mechanism providing guaranteed delivery of short messages to a subscriber, even if the subscriber is inactive when the message was transmitted, by delivering the short messages once the subscriber becomes active. Delivery of all short messages is guaranteed regardless of whether or not the intended subscriber is “on-line” because the transmitted short message is stored within the SMSC, and delivered to the intended subscriber when the subscriber becomes available.

A conventional short message service center (SMSC) is a fixed set of computers with a fixed maximum capacity. Today, demand for short message services (SMS) capacity is growing at a rate that exceeds the rate at which computer technology increases. To handle the increased demand for SMS, additional SMSCs are deployed in a network. In conventional networks, a single SMSC can handle a fixed number of short message services (SMS) short messages. But when that capacity is reached, additional SMSCs must be installed.

Each conventional SMSC has its own unique signaling system No. 7 (SS7) point code and Internet Protocol (IP) address. Each time an SMSC is added to the network, configuration changes throughout the SS7 and IP networks are required.

FIG. 3 shows a conventional SMSC system.

In particular, as shown in FIG. 2, SMSC system 300 includes SMSCs A-1 and A-2 at site A 310a that are mated with SMSCs B-1 and B-2 at site B 310b. The use of a plurality of SMSCs allows SMS short messages to be delivered even when there is a problem at one of the sites 310a and 310b or with one of the SMSCs A-1, A-2, B-1 and B-2.

Each of the SMSC pairs, pair A-1 and B-1, and pair A-2 and

B-2, in their respective site services a distinct group of subscribers of wireless devices 160. For each subscriber, there is data that describes its features and capabilities, which may be maintained either locally on the SMSC A-1, A-2, B-1 and B-2 or remotely on a data server. For each subscriber that has any messages pending, there is a subscriber queue.

In the conventional SMSC system 300, shown in FIG. 3, if there was originally one SMSC pair, e.g., A-1 and B-1, and a new SMSC pair was added, e.g., A-2 and B-2, then half of the subscriber data (if it is maintained locally) and pending messages on the first SMSC pair A-1 and B-1 must be migrated to the second SMSC pair A-2 and B-2. But more importantly, the other network elements must have their routing information changed for SMS messages for half of the subscribers to be sent to the new address, either Point Code, or transmission control protocol/Internet Protocol (TCP/IP) address, depending on the network.

The present inventors have appreciated that this type of conventional technology is disadvantageous in that when expansion is necessary each SMSC added to the SMSC system 300 requires wide ranging configuration changes throughout the network. In addition, each SMSC added to the SMSC system 300 increases the number of network messages required for delivering an SMS message, with messages being forwarded between SMSCs A-1, A-2, B-1 and B-2.

### SUMMARY OF THE INVENTION

In accordance with the principles of the present invention, a system for delivery of packetized messages comprises a first-delivery-attempt system adapted to attempt a first delivery of a packetized message routed to the first-delivery-attempt system. If the first-delivery-attempt system is unsuccessful in delivery of the packetized message forwarding the packetized message to a multiple delivery attempt system, a multiple delivery attempt system is adapted to subsequently repeatedly attempt delivery as necessary of the packetized message. The message forwarded by the first-delivery-attempt system may optionally contain extra data elements beyond those in the original packetized message, added for the purpose of providing the multiple-delivery-attempt system sufficient information for customer billing, message routing, or message delivery decision-making purposes. This allows the systems to operate in a cooperative fashion, as opposed to the simple case of two SMSCs forwarding messages in isolation.

A method of delivering packetized messages in accordance with another aspect of the invention comprises attempting a first delivery of a packetized message from a first short message service center (SMSC) delivery component. Delivery responsibility for the packetized message is forwarded to a second SMSC component if the attempted delivery of the packetized message by the first SMSC delivery component is unsuccessful. Subsequently, delivery of the packetized message is repeatedly attempted from the second SMSC delivery component as necessary.

### BRIEF DESCRIPTION OF THE DRAWINGS

Features and advantages of the present invention will become apparent to those skilled in the art from the following description with reference to the drawings:

FIG. 1 shows an SMSC system with an integrated combination of two different technologies: First-Delivery-Attempt systems, and back-end Multiple-Delivery-Attempt systems that hold both pending messages and subscriber data, in accordance with the principles of the present invention.

FIG. 2 shows an exemplary method of servicing a short message, in accordance with the principles of the present invention.

FIG. 3 shows a conventional SMSC system.

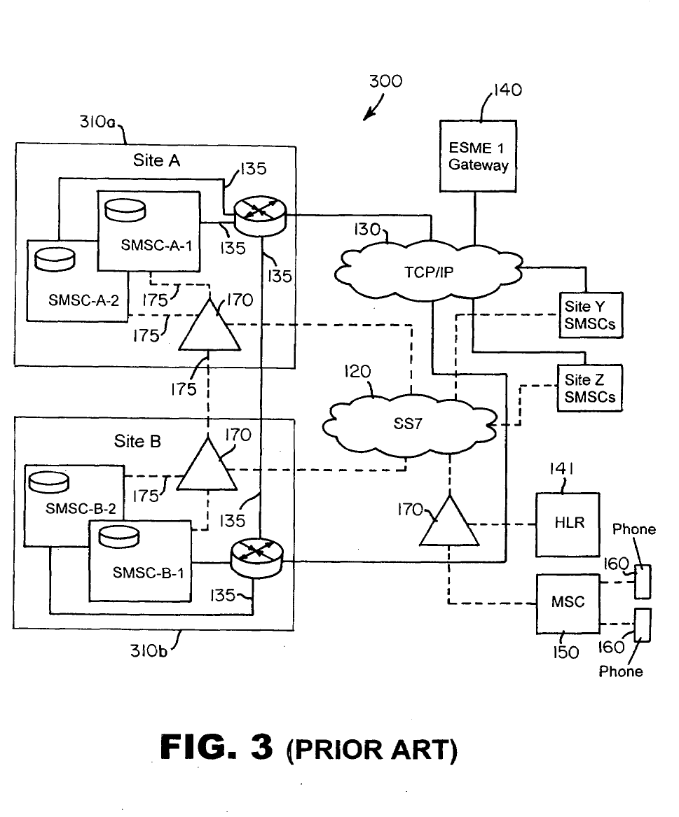

### DETAILED DESCRIPTION OF ILLUSTRATIVE EMBODIMENTS

The present invention provides a novel short messaging service center (SMSC) system 100 that has the ability to have capacity added to it dynamically. The inventive technologies can be applied to other network elements that can act in both a direct-delivery and a store and forward role, such as a Multimedia Messaging Service Center (MMSC).

The present invention provides an SMSC with an integrated combination of two different technologies: First-Delivery-Attempt systems, and back-end Multiple-Delivery-Attempt systems that hold both pending messages and subscriber data. The additional delivery-attempt systems enables the first system to be altered, swapped, or worked on without interrupting pending delivery attempts. The storage of the subscriber data within the Multiple-Delivery-Attempt system is not required to implement this solution, but one application. The system relies on subscriber data that is accessible by or from both the First-Delivery-Attempt system and the Multiple-Delivery-Attempt system. The subscriber data may also optionally be stored on a third component separate and apart from the first or multiple delivery attempt systems to serve solely as a stand-alone data-base component.

First Delivery Attempt (FDA) systems 112a and 112b can act as a state-less buffer between the network 120, and the store-and-forward SMSC/MDAs C-1, C-2, D-1 and D-2 disclosed herein. An FDA acts to attempt delivery without regard for any message delivery order or awareness of pending messages. This is an advantage when the success rate for messages is high, as it is likely that there will be no pending messages. By adding a system that just handles delivery, and does not concern itself with storage, it is possible to introduce a server or cluster of servers that is tuned to efficiently handle that aspect of the message call-flow. This, however, means that any subscriber-related data (service attributes such as pre-paid or post-paid status, subscriber profile or special features) now has to be stored on two different systems—the front-end FDA system, and the back-end SMSC/MDAs C-1, C-2 and D-1 and D-2. The systems 112a and 112b can include individual FDA modules FDA-0, FDA-1 . . . FDA-N. Each FDA module FDA-0, FDA-1 . . . FDA-N can be respectively assigned to attempt delivery of individual messages.

Clustering on the SS7 network 120 or IP round-robining on the TCP/IP network 130 provides a mechanism to distribute the load between a group of systems. This is advantageous in a set of stateless systems, where any server could service the request.

In the case of a conventional SMSC, or similar network element that includes a store-and forward component, there may be a queue of already pending messages in storage. Because of the message storage component, a clustering/round-robin approach would result in a high degree of overhead to reroute the message from the server that initially received the message to the server that holds the subscriber's message queue.

The present invention takes the advantages of the FDA 112 and SMSC/MDA 110 combination, and the advantages of SS7-clustering and IP load-distribution, and adds call-flow and business logic to eliminate the disadvantages created in stand-alone architectures using those technologies in isolation.

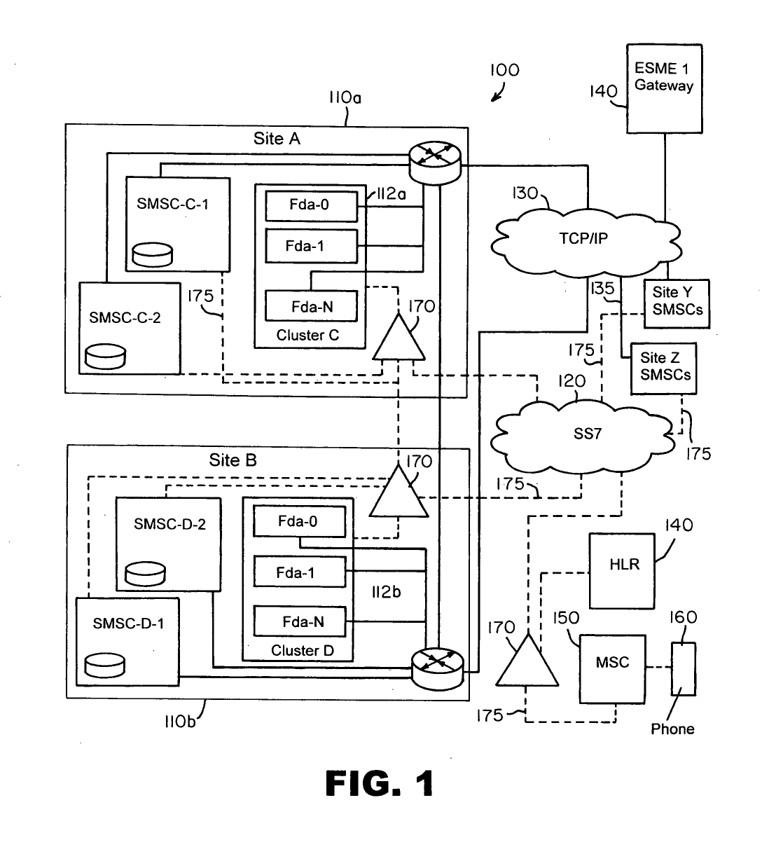

FIG. 1 shows an SMSC system 100 with an integrated combination of two different technologies: First-Delivery-Attempt systems, and back-end Multiple-Delivery-Attempt systems that hold both pending messages and subscriber data, in accordance with the principles of the present invention.

In particular, as shown in FIG. 1, from the SS7 network 120 and IP network 130 perspective, the novel SMSC/MDAs C-1, C-2, D-1 and D-2 and FDA clusters 112a and 112b disclosed herein are a cluster of nodes, any of which can handle an SMS message. The novel SMSC/MDAs C-1, C-2, D-1 and D-2 and FDA clusters 112a and 112b can be accessed through a single SS7 point code and a single IP address. Nodes can be added to the SMSC 100 system to increase capacity, with no configuration changes being required in SS7 network 120 or external IP network 130.

To upgrade existing SMSCs to be operate within the principles disclosed herein, existing SMSCs can be converted into back-end SMSC/MDAs C-1, C-2, D-1 and D-2, with FDA clusters 112a and 112b being added to site C 110a and site D 110b. Preferably they are still mated, and they continue to hold the pending messages (those that cannot be delivered by the FDAs) and perhaps the subscriber data. The front-end FDAs clusters 112a and 112b query the appropriate backend SMSC/MDA C-1, C-2, D-1 and D-2 for subscriber data needed to make the first delivery attempt disclosed herein.

New SMSCs can be added to the SMSC system 100. New SMSC/MDAs C-1, C-2, D-1 and D-2 and FDA clusters 112a and 112b can be added to site C 110a and site D 110b without any new configuration requirements. The newly added SMSC/MDAs C-1, C-2, D-1 and D-2 and FDA clusters can be addressed by an existing addressing scheme. The FDA clusters 112a and 112b, and newly added FDA clusters, provide a single addressing destination for SMSC short messages.

The FDA clusters 112a and 112b and respective SMSC/MDAs C-1, C-2, D-1 and D-2 can be integrated, with the

SMSC/MDAs C-1, C-2, D-1 and D-2 providing the data-storage component for the system for both the subscriber attributes (relatively static subscriber provisioned data) and the subscriber's message queue—transient store and forward message data.

When any of the front-end FDA clusters 112a and 112b receives a message, it queries the back-end SMSC/MDA C-1, C-2, D-1 and D-2 for both subscriber attributes and status of message queue. The FDA clusters 112a and 112b need not know where the subscriber data is stored (whether locally on the SMSC/MDAs C-1, C-2, D-1 and D-2 or remotely on a data server). If the subscriber had queued messages, the FDA system would forward the message on to the appropriate SMSC/MDA C-1, C-2, D-1 and D-2, where the new message could be added to the subscriber queue, thereby preserving message delivery order. If the SMSC/MDA C-1, C-2, D-1 and D-2 indicated that there were no queued messages, the FDA cluster 112a and 112b uses subscriber attributes returned from the SMSC/MDA C-1, C-2, D-1 and D-2 to determine proper handling of the message (allowed/blocked, pre-paid/post-paid) and attempt message delivery accordingly. If the message fails delivery, then it is forwarded to the appropriate SMSC/MDA C-1, C-2, D-1 and D-2 for follow-on delivery attempts.

As in the first example using the current technology (implementation with SMSCs alone), each of the SMSC/MDA pairs, pair C-1 and D-1, and pair C-2 and D-2, services a distinct group of subscribers. In the case above if there was one pair originally (C-1 and D-1), and a new pair was added (C-2 and D-2), then half of the subscriber data, pending messages on the first pair can be migrated to the second pair. The very important distinction is that now the other network elements would not need to make any routing changes—they would still be addressed to the same FDA Point Code and/or IP address as they did prior to the addition of a new pair. The routing changes would be internal to the integrated FDA and SMSC/MDA 110a and 110b solution disclosed herein.

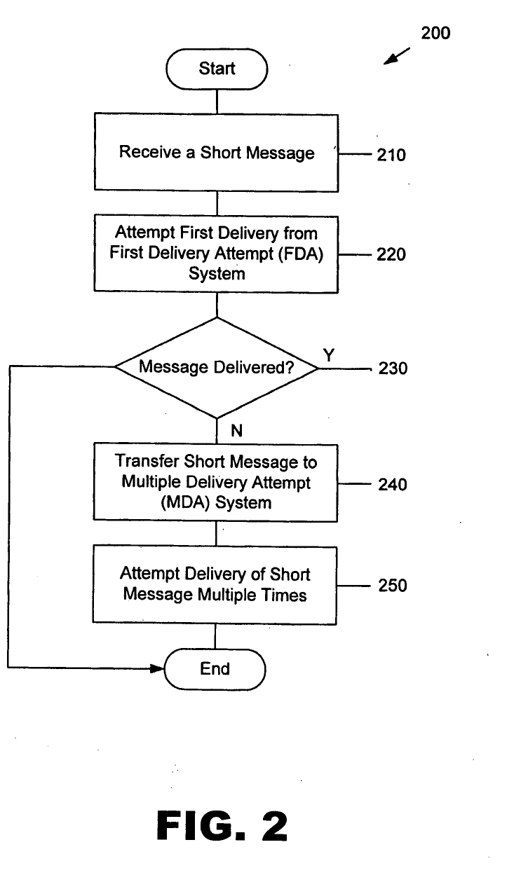

FIG. 2 shows an exemplary method 200 of servicing a short message, in accordance with the principles of the present invention.

In particular, in step 210 a short message is received by any of FDA systems 112a and 112b. The short message addressed to be communicated over the SS7 network 120 with either the integrated FDA and SMSC/MDA 110a and 110b solution disclosed herein. The short message can be passed to any of individual FDA modules FDA-0, FDA-1 . . . FDA-N. The short message can be passed to any of individual FDA modules FDA-0, FDA-1 . . . FDA-N based on a number of message distribution schemes that include round-robin, weighted round-robin, fair queuing, weighted fair queuing, etc.

In step 220, the particular individual FDA module FDA-0, FDA-1 . . . FDA-N that received the short message in step 210 attempts a first delivery of the short message. FDA module FDA-0, FDA-1 . . . FDA-N that received the short message in step 210 determines if any short messages are awaiting delivery in a queue for a particular subscriber associated with the short message. If no short messages are awaiting delivery for a particular subscriber, the particular individual FDA module FDA-0, FDA-1 . . . FDA-N attempts to communicate with a wireless device 160, or any other destination device that the short message is addressed to. If the particular individual FDA module FDA-0, FDA-1 . . . FDA-N is able to establish communications with a wireless device 160, the particular individual FDA module FDA-0, FDA-1 . . . FDA-N transmits the short message to the wireless device 160.

In step 230, a determination is made if the short message delivery attempt from step 220 is successful. The particular individual FDA module FDA-0, FDA-1 . . . FDA-N that attempted a first delivery in step 220 can set a database record indicating that a short message delivery for the short message received in step 210 was successful. If the short message delivery was successful, the process flow ends for that particular short message. If the short message delivery attempt was unsuccessful, the process flow branches to step 240 to subsequently attempt delivery of the short message.

In step 240, the short message that was unsuccessfully delivered in 220 is transferred to the appropriate store-and-forward SMSC/MDAs C-1, C-2, D-1 and D-2 disclosed herein. The short message is passed to the individual store-and-forward SMSC/MDAs C-1, C-2, D-1 and D-2 based on a number of message distribution schemes that include modulo, specified routing, etc., as long as the routing scheme associates an individual subscriber's message queue with one system (and optionally with an associated backup system for fail-over conditions).

In step 250, the individual store-and-forward SMSC/MDAs C-1, C-2, D-1 and D-2 that received the transfer of the short message in step 240 subsequently attempts delivery of the short message. The short message can be stored in a queue, e.g., a first-in-first-out queue, for subsequent attempts at delivering the short message.

The invention has particular applicability with wireless providers. The present invention can reduce the number of SMSCs needed in a network, which reduces the load on the SS7 network 120 because there is less message forwarding between SMSCs (for example, one SMSC per site instead of three). The invention also allows for capacity to be added dynamically, by increasing the number of front-end FDAs clusters 112a and 112b and/or the number of back-end SMSC MDAs C-1, C-2, D-1 and D-2.

The message being delivered is described herein as a “short message”. However, the “short message” described herein can be any of a Short Messaging Service (SMS) message, a Multimedia Service (MMS) message, or a combination thereof. Moreover, for simplicity only, the message service centers are described as being Short Message Service

Centers (SMSCs). However, the principles disclosed herein apply equally to the Multimedia Service Centers (MMSCs).

While the invention has been described with reference to the exemplary embodiments thereof, those skilled in the art will be able to make various modifications to the described embodiments of the invention without departing from the true spirit and scope of the invention.

What is claimed is:

1. A system for delivery of packetized messages, comprising:
a first-delivery-attempt system adapted to attempt a first delivery of a packetized message routed to said first-delivery-attempt system, and if said first-delivery-attempt system is unsuccessful in delivery of said packetized message forwarding said packetized message to a multiple delivery attempt system where each systems shares access to a subscriber database;
said first-delivery-attempt system providing any necessary meta-data in addition to the patcketized message to enable said multiple delivery attempt system to perform appropriate billing, routing, or other functions even though it was not the original recipient of the packetized message;
said subscriber database being accessible by both the first-delivery-attempt-system and multiple-delivery-attempt-system to provide data elements describing profile information of originators and/or terminating subscribers for the packetized message; and
said multiple delivery attempt system being adapted to subsequently repeatedly attempt delivery as necessary of said packetized message.

2. The system for delivery of packetized messages according to claim 1, wherein said first-delivery-attempt system comprises:
a cluster of first-delivery-attempt modules.

3. The system for delivery of packetized messages according to claim 1, wherein said multiple delivery attempt system comprises:
a multiple-delivery-attempt module.

4. The system for delivery of packetized messages according to claim 1, wherein said subscriber database system comprises:
a subscriber related database.

5. The system for delivery of packetized messages according to claim 1, wherein:
said packetized message is addressed to said first-delivery-attempt system using one of: a single SS7 point code, and a single Internet Protocol (IP) address

6. The system for delivery of packetized messages according to claim 1, wherein:
said packetized message is a Multimedia Messaging Service (MMS) digital message.

7. The system for delivery of packetized messages according to claim 1, wherein:
said packetized message is a short message service center (SMSC) digital message.

8. The system for delivery of packetized messages according to claim 1, further comprising:
a second multiple delivery attempt system adapted to be added to said system for delivery of packetized messages forwarded by said first-delivery-attempt system without requiring a service center address change for said packetized messages.

9. A method of delivering packetized messages, comprising:
attempting a first delivery of a packetized message from a first short message service center (SMSC) delivery component;
forwarding delivery responsibility for said packetized message to a second SMSC component if said attempted delivery of said packetized message by said first SMSC delivery component is unsuccessful;
subsequently repeatedly attempting delivery of said packetized message from said second SMSC delivery component as necessary; and
accessing subscriber data in a subscriber database component that is available to both the first and second SMSC delivery components.

10. The method of delivering packetized messages according to claim 9, wherein said first-delivery-attempt system comprises:
a cluster of first-delivery-attempt modules.

11. The method of delivering packetized messages according to claim 9, further comprising:
storing pending message data in said second SMSC delivery component.

12. The method of delivering packetized messages according to claim 9, further comprising:
accessing and storing subscriber-related data in a subscriber database component accessible by both the said first and second SMSC delivery component.

13. The method of delivering packetized messages according to claim 9, wherein:
said packetized message is addressed to said first SMSC delivery component using one of: a single SS7 point code, and a single Internet Protocol (IP) address.

14. The method of delivering packetized messages according to claim 9, wherein:
said packetized message is a Multimedia Messaging Service (MMS) digital message.

15. The method of delivering packetized messages according to claim 9, wherein:
said packetized message is a Short Message Service Center (SMSC) message.

16. The method of delivering packetized messages according to claim 9, further comprising:
adding a second multiple delivery attempt system to said system for delivery of packetized messages without requiring a service center address change for said packetized messages.

17. Apparatus for delivering packetized messages comprising:
means for attempting a first delivery of a packetized message from a first short message service center (SMSC) delivery component;
means for forwarding delivery responsibility for said packetized message to a second SMSC component if said attempted delivery of said packetized message by said first SMSC delivery component is unsuccessful; and
means for subsequently repeatedly attempting delivery of said packetized message from said second SMSC delivery component as necessary.

18. The apparatus for delivering packetized messages according to claim 17, wherein said means for attempting a first delivery comprises:
a cluster of first-delivery-attempt modules.

19. The apparatus for delivering packetized messages according to claim 17, further comprising:
means for storing subscriber-related data in said second SMSC delivery component.

20. The apparatus for delivering packetized messages according to claim 17, wherein:
said packetized message is addressed to said first SMSC delivery component using one of: a single SS7 point code, and a single Internet Protocol (IP) address.

21. The apparatus for delivering packetized messages according to claim 17, wherein:
said packetized message is a Multimedia Messaging Service (MMS) digital message.

22. The apparatus for delivering packetized messages according to claim 17, wherein:
said packetized message is a Short Message Service Center (SMSC) message.
